(19) United States
(12) Patent Application Publication
(10) Pub. No.: US 2025/0089731 A1
(43) Pub. Date: Mar. 20, 2025

(54) FRESHNESS PRESERVATION METHOD AND FRESHNESS PRESERVATION SYSTEM FOR FRUITS AND VEGETABLES

(71) Applicant: NICHIA CORPORATION, Anan-shi (JP)

(72) Inventors: Tomohiro TSURUMOTO, Kawasaki-shi (JP); Yasuo FUJIKAWA, Yokohama-shi (JP)

(21) Appl. No.: 18/884,927

(22) Filed: Sep. 13, 2024

(30) Foreign Application Priority Data
Sep. 15, 2023 (JP) 2023-149801
May 14, 2024 (JP) 2024-078849

(51) Int. Cl. A23B 7/015; A23L 3/00; A23L 3/28

(52) U.S. Cl. CPC A23B 7/015; A23B 2/001; A23B 2/53

(57) ABSTRACT

A freshness preservation method for fruits and vegetables includes irradiating fruits or vegetables within 24 hours after harvest with light having a peak wavelength in a range from 256 nm to 297 nm, thereby extending, by equal to or greater than 25% compared to when the fruits or the vegetables are not irradiated by the light, time for preserving equal to or greater than 95% of a weight of the fruits or the vegetables before light irradiation.

### CROSS-REFERENCE TO RELATED APPLICATIONS

This application claims priority to Japanese Patent Application No. 2023-149801, filed on Sep. 15, 2023, and Japanese Patent Application No. 2024-078849, filed on May 14, 2024, the disclosures of which are hereby incorporated herein by reference in their entirety.

### TECHNICAL FIELD

The present disclosure relates to a freshness preservation method and a freshness preservation system for preserving freshness of fruits and vegetables.

### BACKGROUND

There is a known method for preserving freshness of fruits and vegetables by irradiating harvested fruits and vegetables with light. Japanese Patent Publication No. JP 2017-093433 discloses a method for preserving freshness of fruits and vegetables including strawberries by irradiating them with near-infrared light in a range of, for example, from 700 nm to 2500 nm.

### SUMMARY

One aspect of the present disclosure is directed to providing a method that can preserve the freshness of fruits and vegetables also with a wavelength other than near-infrared light.

A freshness preservation method for fruits and vegetables disclosed in one embodiment is a method including irradiating fruits or vegetables within 24 hours after harvest with light having a peak wavelength in a range from 256 nm to 297 nm, thereby extending, by equal to or greater than 25% compared to when the fruits or the vegetables are not irradiated by the light, time for preserving equal to or greater than 95% of a weight of the fruits or the vegetables before light irradiation.

At least one of the embodiments of the disclosure can achieve a method that can preserve freshness of fruits and vegetables.

### BRIEF DESCRIPTION OF THE DRAWINGS

FIG. 1 is a chart showing a storage test result of Experiment 1.

FIG. 2A is a photograph showing a state of a stoma observed with an optical microscope.

FIG. 2B is a photograph showing a state of a stoma observed with an optical microscope.

FIG. 3 is a chart showing a storage test result of Experiment 2.

FIG. 4 is a chart showing a storage test result of Experiment 3.

FIG. 5 is a chart showing a storage test result of Experiment 4.

FIG. 6 is a chart showing a hardness measurement result using a sample of Experiment 4.

FIG. 7 is a chart showing an antioxidant property measurement result using the sample of Experiment 4.

FIG. 8 is a chart showing a measurement result of fisetin content using the sample of Experiment 4.

FIG. 9 is a chart showing a measurement result of nitrate nitrogen concentration using the sample of Experiment 4.

FIG. 10 is a chart illustrating spectra of light sources used in Experiment 1 to Experiment 10.

FIG. 11 is a chart showing a storage test result of Experiment 5.

FIG. 12 is a chart showing a storage test result of Experiment 6.

FIG. 13 is a chart showing a storage test result of Experiment 7.

FIG. 14 is a chart showing a storage test result of Experiment 8.

FIG. 15 is a chart showing a storage test result of Experiment 9.

FIG. 16 is a chart showing a storage test result of Experiment 10.

FIG. 17 is a schematic diagram illustrating a light irradiation device that can be used in the present embodiment.

FIG. 18 is a system configuration diagram of a freshness preservation system according to the present embodiment.

### DETAILED DESCRIPTION

The present disclosure is, from one point of view, a freshness preservation method for fruits and vegetables. The method includes irradiating fruits and vegetables within 24 hours after harvest with light having a peak wavelength in a range from 256 nm to 297 nm, thereby extending, by equal to or greater than 25%, time for preserving equal to or greater than 95% of a weight of the fruits and vegetables before the light irradiation.

As shown in experiment examples described later, the present disclosure is based on a new finding that it is possible to extend a freshness preservation duration by irradiating fruits and vegetables such as strawberries with light having a wavelength of around 280 nm. In distribution and storage of fruits and vegetables, freshness preservation is extremely important because it affects the commercial value. For example, there is a need for extending, even by one more day, the freshness preservation duration of fruits and vegetables having a poor shelf life such as strawberries.

The freshness of fruits and vegetables can be evaluated by, for example, a weight loss amount (in other words, transpiration amount). In many fruits and vegetables, a loss in weight of equal to or greater than 5% with respect to the weight at the time of harvest significantly impairs the quality of the commercial product. Therefore, in the present description, preserving equal to or greater than 95% of the weight of fruits and vegetables within 24 hours after harvest is defined as successfully preserving freshness. The number of days of 95% weight preservation is used as a freshness index.

In the present embodiment, the fruits and vegetables are irradiated with light in a wavelength range effective for extending the time for preserving equal to or greater than 95% of the weight of the fruits and vegetables, that is, a range from 256 nm to 305 nm, more specifically, 256 nm to 297 nm, and yet more specifically, 270 nm to 297 nm. This wavelength range also has a sterilization effect.

The light in the above wavelength range can be light extracted by using an optical filter from a light source that emits light having a wide wavelength spectrum such as a halogen lamp. The light may include light from a light source of a light emitting diode (LED) or a laser diode (LD), or may be only such light. Use of the LED or the LD is preferable also from the viewpoint of energy efficiency and economy due to energy intensity, low heat generation, low power consumption, and long life. In addition, control or management of the irradiation amount is made easy. Use of the LED with a lens enables a region desired to be irradiated to be efficiently irradiated.

The irradiation amount (also called integrated light amount) of light having the above wavelength is not particularly limited as long as it is an amount effective for extending the time for preserving equal to or greater than 95%, more preferably equal to or greater than 968, and yet more preferably equal to or greater than 97% of the weight of the fruits and vegetables. The specific irradiation amount can vary depending on the type and variety of the fruits and vegetables to be used, but the specific irradiation amount can be in a range, for example, from 5 mJ/cm² to 100 mJ/cm², preferably 5 mJ/cm² to 64 mJ/cm², and more preferably 5 mJ/cm² to 60 mJ/cm². This irradiation amount is a range in which a freshness preservation effect has been confirmed in experiment examples of strawberries described later, but is considered to be applicable also to other fruits and vegetables. In the present description, the “irradiation amount” refers to an irradiation amount on a light receiving surface of fruits and vegetables.

The illuminance of the light having the above wavelength is also not particularly limited as long as it is an amount effective for extending the time for preserving equal to or greater than 95%, more preferably equal to or greater than 96%, and yet more preferably equal to or greater than 97% of the weight of the fruits and vegetables. For example, it can be in a range from 0.1 mW/cm² to 100 mW/cm², preferably from 0.1 mW/cm² to 50 mW/cm², and more preferably from 0.3 mW/cm² to 50 mW/cm². This illuminance is a range in which the freshness preservation effect has been confirmed in experiment examples of strawberries described later, but is considered to be applicable also to other fruits and vegetables.

The irradiation time of light having the above wavelength is not particularly limited as long as it is a time effective for extending the time for preserving equal to or greater than 95% of the weight of the fruits and vegetables, and can be in a range, for example, from 0.1 seconds to 180 seconds, preferably 2 from seconds to 180 seconds, and more preferably from 2 seconds to 18 seconds. When the irradiation time is too short or too long, sometimes the effect of weight preservation cannot be achieved.

The time for extending the time for preserving equal to or greater than 95% of the weight of the fruits and vegetables is preferably extended by equal to or greater than 25% (i.e., 1.25 times) as compared with the case of non-irradiation. The time can be extended more preferably by equal to or greater than 30%, yet more preferably by equal to or greater than 508. The time for extending the time for preserving equal to or greater than 95% of the weight of the fruits and vegetables can be calculated by measuring the weights of a light irradiation sample for which the present disclosure is carried out and a non-irradiation sample for which the present disclosure is not carried out. The light irradiation sample and the non-irradiation sample are the same fruits and vegetables harvested on the same day in the same cultivation field, and conditions other than the presence or absence of light irradiation, such as the storage condition, are the same. The storage condition may be any storage condition suitable for the fruits and vegetables.

The light irradiation may be directly applied to the epidermis of fruits and vegetables, or may be applied in a state where the fruits and vegetables are contained in a translucent case and put in the case. The case may be light transmissive, but may be provided with an opening for allowing light to enter.

The light irradiation can be performed in a state where fruits and vegetables are placed on a placement member having a placement surface with an average reflectance of emitted light of equal to or greater than 20%, preferably equal to or greater than 30%, and more preferably equal to or greater than 408. The placement member may be a tray or a container for storing fruits and vegetables, for example.

Light having the above wavelength may be emitted as continuous light or may be emitted as intermittent light (e.g., pulsed light). Light having the above wavelength may be emitted alone, or may be emitted in combination with light having another wavelength. In this case, the two types of light may be emitted simultaneously (as combined light or mixed light) or may be emitted alternately.

Light irradiation can be performed within 24 hours, preferably within 12 hours, more preferably within 6 hours, after harvest. The shorter the time after harvest, the more sensitive the fruits and vegetables are to light, which is preferable. For example, light may be emitted from above in a state where the fruits and vegetables are put in a tray or a container storing the fruits and vegetables after harvesting. In order to irradiate the back side (i.e., the side in contact with the placement surface of a storage case) of the fruits and vegetables with light, the bottom of the storage case may have an opening small enough for the fruits and vegetables not to drop. Alternatively, the bottom of the storage case may be net-shaped. Alternatively, the bottom of the storage case may have a light transmissive window. The light irradiation may be a conveyor type or may be a batch type. For example, an irradiation device that can emit light from above a conveyor used in a sorting process of fruits and vegetables can be used.

Alternatively, before the fruits and vegetables held for harvesting are placed in a predetermined place, the fruits and vegetables may be inserted into the light irradiation device for several seconds to irradiate the fruits and vegetables with light. A harvest robot may include the light irradiation device, and may perform harvest and light irradiation almost simultaneously. The “almost simultaneously” mentioned here means that irradiation is started within one minute after harvest. This enables light irradiation to be performed immediately after harvest.

It is considered that the freshness preservation effect can be obtained even by performing light irradiation not after harvest but immediately before harvest or during cultivation. The “immediately before harvest” mentioned here means a period from one week before harvest to the harvest.

The light irradiation may be performed after sorting. For example, it is possible to extend the freshness preservation duration more effectively by performing ripeness sorting and scratch sorting to select fruits and vegetables that are not too ripe and have few scratches, and then irradiating the fruits and vegetables with light. Fruits and vegetables too ripe tend to have a poor freshness preservation effect even when irradiated with light because the pericarp is already soft and easily scratched at the stage before the light irradiation. Since scratched fruits and vegetables can be unsuitable as a product on their own, it is preferable to exclude such fruits and vegetables from the target of light irradiation in advance. This enables fruits and vegetables having a long freshness preservation duration after light irradiation to be sorted, and therefore fruits and vegetables suitable for export can be obtained.

The ripeness sorting may be performed by checking the chromaticity of fruits and vegetables, for example. The chromaticity can be quantified by any method depending on the type of fruits and vegetables. Alternatively, the ripeness sorting may be performed by measuring the hardness of the pericarp. The hardness can be measured by a contact type fruit needle hardness tester or the like, or a non-contact type measuring instrument. Examples of a non-contact type measuring instrument include a method of measuring the hardness by applying compressed air to fruits and vegetables and measuring a temporal change of a recess with a laser distance sensor. This principle can be said to be a principle similar to that of an intraocular pressure measuring instrument. The presence or absence of a scratch can be measured by a camera-based observation of a fruit sorting machine.

For non-ripened fruits and vegetables, those with a high sugar content may be sorted. The sugar content can be measured with a predetermined non-contact sugar content meter.

If a case such as a pack for shipping to a consumer is translucent, light irradiation may be performed in a state where the fruits and vegetables are put in the case.

In the present description, fruits and vegetables are not particularly limited. Examples of fruits and vegetables include plants of Brassicaceae (in particular, Brassica and Raphanus), Solanaceae (in particular, Solanum), Berberidaceae (in particular, Podophyllum), Theaceae (in particular, Camellia), Fabaceae (in particular, Glycine), Rutaceae (in particular, Citrus), Vitaceae (in particular, Vitis), Rosaceae (in particular, Fragaria), Asteraceae (in particular, Lactuca), and Lamiaceae (in particular, Perilla). Specific examples of the fruits and vegetables that can be used in the present disclosure include thale cress, mayapple, tea plant, soybean, sudachi, grape, cabbage, broccoli, Japanese mustard spinach, bok choy, radish, turnip, tomato, eggplant, strawberry, lettuce, banana, avocado, apple, peach, blueberry, cherry, mango, fig, beefsteak plant, and cucumber.

In the present description, the fruits and vegetables can be fruits and vegetables having UVR8 photoreceptors. As described in detail in experiment examples described later, the mechanisms in which freshness can be preserved by irradiation with ultraviolet light include at least the following two. One of them is considered to be due to the fact that a stoma is easily closed by irradiation with ultraviolet light and moisture evaporation is reduced. The other of them is considered to be due to the fact that softening of the pericarp is suppressed by irradiation with ultraviolet light and moisture evaporation is reduced. These mechanisms are related to UVR8 photoreceptors, which are receptors for ultraviolet light. Since land plants and green alga including the fruits and vegetables described above have UVR8 photoreceptors, it is considered that reduction in moisture evaporation due to stoma closure and preservation of pericarp hardness is applicable in principle not only to strawberries but also to postharvest fruits and vegetables having UVR8 photoreceptors.

According to the experimental results described later, when strawberries are irradiated with light having a peak wavelength of 280 nm, ultraviolet response by the UVR8 photoreceptor gives, in addition to the effects described above, effects of an increase in the DPPH radical scavenging activity value and the fisetin content, which contribute to the antioxidant property, and a decrease in the nitrate nitrogen concentration. Therefore, the freshness preservation method of the present embodiment can impart a preferable function for human health to fruits and vegetables.

### Light Irradiation Device

The light irradiation device may irradiate fruits and vegetables with light having a predetermined wavelength. The light irradiation device may be one in which an existing quality inspection device using X-rays or infrared rays is attached with a light emitting device such as an LED. These inspection devices operate in a protected structure to ensure inspection accuracy and human body safety. Since the inspection device has a structure in which the worker is not irradiated with irradiation light, it is not necessary to separately provide a light shielding structure.

Since the ultraviolet light emitted in the present embodiment is invisible to human eyes, it is sometimes not possible to visually determine whether or not the irradiation is being performed. Therefore, in consideration of safety, visible light may be simultaneously emitted at the time of irradiation with ultraviolet light. The photon flux density of visible light is, for example, equal to or less than 300 μmol/m²/s, preferably equal to or less than 100 μmol/m²/s. Alternatively, a wavelength conversion member that is excited by ultraviolet light and emits light may be disposed at a part irradiated with ultraviolet light, whereby whether or not ultraviolet light is emitted can be confirmed.

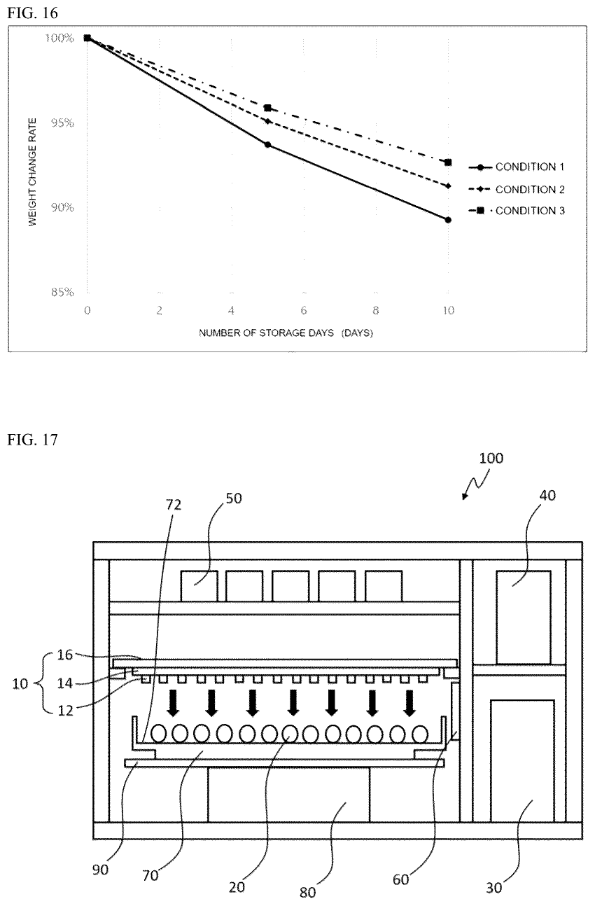

FIG. 17 is an example of the light irradiation device used in the present embodiment. A light irradiation device 100 is a batch type light irradiation machine, and includes an LED module 10, a stage 90 on which fruits and vegetables 20, which is an irradiation target, are placed, an LED power supply 30, a sequencer 40, and a plurality of fans 50. For easy understanding of the internal structure, the front door is omitted in the drawing.

The LED module 10 includes an LED 12, an LED mounting board 14, and a heat sink 16. The number of LEDS to be equipped may be any number as long as a required irradiation amount can be secured, and may be, for example, about from 100 to 200. The heat sink 16 is a member for dissipating heat generated when the LED is driven. As a material of the heat sink 16, a metal material such as aluminum or copper can be suitably used.

The plurality of fans 50 for air-cooling the heat sink 16 are provided above the heat sink 16. The sequencer 40 can control output of the LED 12 according to a predetermined program, and can also control the fans 50 in conjunction with the driving state of the LED 12.

A jack 80 with variable vertical height is provided under the stage 90, and a distance from the light emitting surface of the LED 12 to the irradiation target can be adjusted. A height confirmation measure 60 provided on the side of the stage 90 can measure the distance from the light emitting surface of the LED 12 to the irradiation target.

The fruits and vegetables 20 are placed directly or indirectly on the stage 90. In FIG. 17, the fruits and vegetables 20 are placed on the stage 90 in a state of being placed on a placement surface 72 of a tray 70. Light emitted from the LED 12 is emitted in a direction indicated by the arrow in FIG. 17, and the surface of the fruits and vegetables 20 is irradiated with the light.

### Freshness Preservation System

An example of a system (freshness preservation system 1000) using the freshness preservation method of the present embodiment will be described. Fruits and vegetables are delivered to consumers through, for example, a route from a cultivator such as a farmer to a shipping association such as an agricultural cooperative, from the shipping association to a wholesale market, and from the wholesale market to a retailer such as a supermarket and a greengrocer's shop. As another route, fruits and vegetables may be delivered to consumers through a route from a cultivator such as a farmer to a food processor, and from the food processor to a retailer such as a supermarket or a convenience store as a processed food product. In particular, for a processed food product that is mass-produced in a specific season, such as strawberries of cakes in the Christmas season, fruits and vegetables may be stored in a large amount as a raw material in a food processor for a certain duration of time.

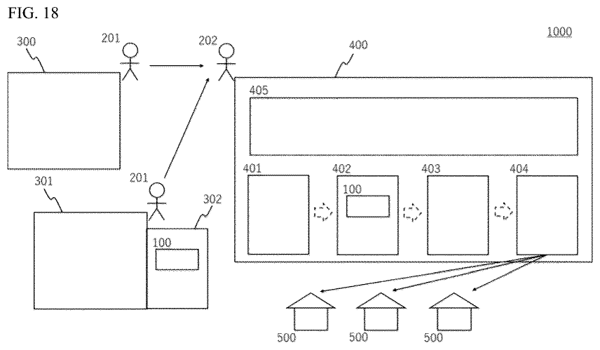

As illustrated in FIG. 18, the freshness preservation system 1000 includes a cultivation space 300 (an agricultural land, a plant factory, or the like) for cultivating fruits and vegetables possessed by each of one or a plurality of cultivators 201, and a management space 400 for fruits and vegetables possessed by a user 202 of the freshness preservation method of the present embodiment. The management space 400 includes a collection space 401 for collecting fruits and vegetables, an irradiation space 402 in which the light irradiation device 100 is installed and the freshness preservation method of the present embodiment is performed on the fruits and vegetables, and a storage space 403 for storing the fruits and vegetables on which the freshness preservation method of the present embodiment is performed. Furthermore, the management space 400 includes a processed food product manufacture space 404 for processing stored fruits and vegetables to manufacture a processed food product. Furthermore, the user 202 himself/herself may have a cultivation space 405 for cultivating fruits and vegetables.

In the freshness preservation system 1000, the user 202 of the management space 400 collects, into the collection space 401, a plurality of fruits and vegetables cultivated by the one or the plurality of cultivators 201, carries the plurality of collected fruits and vegetables to the irradiation space 402, and irradiates each of the plurality of conveyed fruits and vegetables with light by the light irradiation device 100. The plurality of fruits and vegetables irradiated with light by the light irradiation device 100 are stored in the storage space 403 under appropriate temperature management. In the processed food product manufacture space 404, a necessary quantity of fruits and vegetables are carried from the plurality of fruits and vegetables stored in the storage space 403, and a processed food product in which the fruits and vegetables are processed is manufactured. The manufactured processed food product is delivered to a store 500 run by the user 202, a store 500 contracted with the user 202, and the like. The contract between the user 202 and the store 500 can include a normal sales contract and a franchise contract.

In the freshness preservation method of the present embodiment, it is preferable that a time from when fruits and vegetables are harvested to when the fruits and vegetables are irradiated with ultraviolet light is short. Irradiation with ultraviolet light is preferably performed, for example, within 24 hours after harvest, and more preferably within 12 hours after harvest. Therefore, it is preferable that the user 202 collects fruits and vegetables from the cultivator 201 who can carry the fruits and vegetables to the collection space 401 before a predetermined preferable time elapses after harvest. For example, it is conceivable to set an upper limit to a linear distance from the management space 400 or the collection space 401 and select the cultivator 201. For example, the cultivation space 405 within 100 km from the management space 400 or the collection space 401 can be targeted. Since it is preferable to collect fruits and vegetables in a shorter time from the harvest, it is preferable to collect fruits and vegetables from the cultivation spaces 300 and 405 in a range within 20 km, preferably within 5 km, and more preferably within 1 km, from the management space 400 or the collection space 401. Even in a case in which the user 202 himself/herself cultivates and harvests fruits and vegetables in the cultivation space 405, the distance from the management space 400 or the collection space 401 to the cultivation space 405 preferably satisfies the above-described condition.

For example, by collecting fruits and vegetables within a predetermined time from harvest (where the predetermined time is a time within 24 hours after harvest) in the management space 400 including the collection space 401 for collecting fruits and vegetables, the irradiation space 402 for irradiating the fruits and vegetables with light, and the storage space 403 that is temperature-controlled for storing the fruits and vegetables, it is possible to emit light at an initial stage of distribution, and it is possible to effectively achieve freshness preservation of the fruits and vegetables.

The fruits and vegetables are collected in the collection space 401 from the cultivation spaces 300 and 405. The collection space 401 is preferably temperature-managed. The person who transports the fruits and vegetables to the collection space 401 may be the cultivator 201, the user 202, or a transporter.

In the irradiation space 402, one or a plurality of light irradiation devices 100 are installed. In order to irradiate fruits and vegetables with light as early as possible after harvest, it is preferable that the collection space 401 and the irradiation space 402 be installed in the same building. The collection space 401 may be included in the irradiation space 402. In other words, one space may be both the collection space 401 and the irradiation space 402.

Irradiation of the fruits and vegetables with ultraviolet light by the light irradiation device 100 is preferably performed within 24 hours, preferably within 12 hours, and more preferably within 6 hours after harvest of the fruits and vegetables. In the irradiation space 402, irradiation with ultraviolet light in accordance with the above-described freshness preservation method is performed by the light irradiation device 100.

The fruits and vegetables irradiated with ultraviolet light by the light irradiation device 100 are stored in the storage space 403. The storage space 403 is preferably installed in the same building as the irradiation space 402. The storage space 403 preferably not only is temperature managed but also is humidity managed. It is possible to effectively achieve freshness preservation of fruits and vegetables by completing from collection to storage of the fruits and vegetables in one facility or factory.

Before irradiating fruits and vegetables with light, an identifier for identifying the fruits and vegetables may be imparted to the fruits and vegetables or a case such as a tray or a container storing the fruits and vegetables. The identifier is associated with various pieces of information necessary for light irradiation. By reading the identifier before light irradiation, appropriate light irradiation can be performed. For example, by associating the harvest time with the identifier, it is possible to exclude, from the light irradiation target, fruits and vegetables with which 24 hours have elapsed after harvest, and irradiate only the fruits and vegetables within 24 hours after harvest with light. Alternatively, by associating the height information of fruits and vegetables with the identifier, it is possible to control the illuminance and the irradiation distance. Alternatively, by associating a light irradiation history with the identifier, it is possible to prevent erroneously irradiating a plurality of times or shipping without irradiation.

The management space 400 can include the processed food product manufacture space 404. In the processed food product manufacture space 404, for example, fruits and vegetables are cut or processed into a jelly, yogurt, western confectionery, Japanese confectionery, or the like using fruits and vegetables. As one preferable mode of the freshness preservation system 1000, a mode in which the user 202 who manufactures and sells a processed food product performs from collection to storage of fruits and vegetables is considered. This is because those who manufacture a processed food product need to manage the stock of materials to some extent for the manufacture of the processed food product, and they are likely to desire to preserve, as much as possible, freshness of fruits and vegetables that are difficult to keep long. Therefore, it is preferable that the irradiation space 402 and the storage space 403 are installed in the same building as the processed food product manufacture space 404 owned by the user who manufactures and sells a processed food product. Regarding the expression “installed in the same building” used so far, this includes not only the meaning of being installed strictly in one physical building but also the meaning of being installed in any of a plurality of buildings when the plurality of buildings are present on the premises.

The freshness preservation system 1000 may further include an irradiation space 302 having the light irradiation device 100 in or adjacent to a cultivation space 301. For example, by lending the light irradiation device 100 from the user 202 to the cultivator 201, the cultivator 201 can provide the irradiation space 302 in or near the cultivation space 301. The cultivator 201 irradiates the fruits and vegetables harvested in the cultivation space 301 with light using the light irradiation device 100, and transports, to the management space 400, the fruits and vegetables already irradiated with light, in other words, the fruits and vegetables on which the freshness preservation method has been performed. The fruits and vegetables transported to the management space 400 are stored in the storage space 403 without requiring performing of the freshness preservation method in the management space 400.

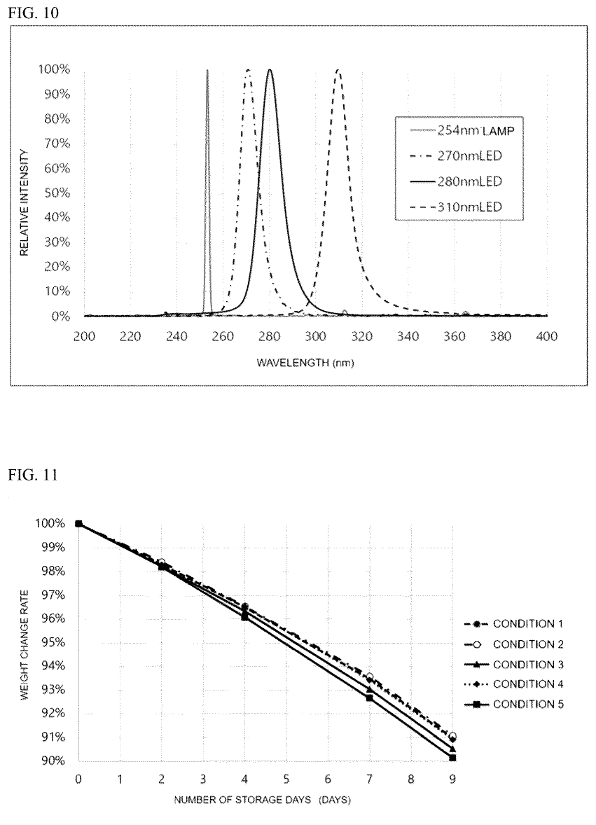

Hereinafter, results of Experiment 1 to Experiment 10 will be described in detail with examples of strawberries, cucumbers, and broccoli. FIG. 10 shows emission spectra of a 280 nm LED used in Experiment 1 to Experiment 4 and Experiment 7 to Experiment 10, a 254 nm lamp and a 310 nm LED used in Experiment 5, and a 270 nm LED used in Experiment 6. As described above, the present disclosure is applicable not only to strawberries, cucumbers, and broccoli but also to other fruits and vegetables.

### EXAMPLES

### Experiment 1

Strawberries with which about 2 hours have elapsed after harvest were irradiated with LED light having a peak wavelength of 280 nm. For the strawberries, Pechika Honoka, which is an ever-bearing strawberry for summer and autumn harvest, was used. The strawberries were placed on a wire mesh, and LEDs were placed on the top and bottom of the wire mesh to irradiate the strawberries from both sides. The irradiation conditions such as the irradiation amount, illuminance, and irradiation time are as in Table 1.

TABLE 1

| | | IRRADIATION | ILLUMINANCE | IRRADIATION |
|---|---|---|---|---|
| | IRRADIATION METHOD | AMOUNT mJ/cm² | mW/cm² | TIME SECONDS |
| CONDITION 1 | NON-IRRADIATION | 0 | 0 | 0 |
| CONDITION 2 | BOTH SIDES IRRADIATION | 18 | 1 | 18 |
| CONDITION 3 | BOTH SIDES IRRADIATION | 54 | 3 | 18 |
| CONDITION 4 | BOTH SIDES IRRADIATION | 180 | 10 | 18 |
| CONDITION 5 | BOTH SIDES IRRADIATION | 306 | 17 | 18 |
| CONDITION 6 | BOTH SIDES IRRADIATION | 414 | 23 | 18 |

After the light irradiation, 8 strawberries were put in a food pack for each of the irradiation conditions and stored in an incubator at 15° C. The relative humidity was about 608. The material of the food pack was a styrene resin, and the strawberries were stored in a state where the lid of the food pack was closed. Even with the lid being closed, the food pack was not hermetically sealed, and air flowed in and out.

Before storage (a number of storage days of 0 days), after 2 days, after 3 days, after 4 days, after 5 days, after 6 days, and after 10 days from the start of storage, the food pack was taken out from the incubator, and subjected to weight measurement and appearance check. The weight was measured collectively for each food pack, and the weight of the food pack measured in advance was subtracted from the measured value to calculate the weight of the 8 strawberries.

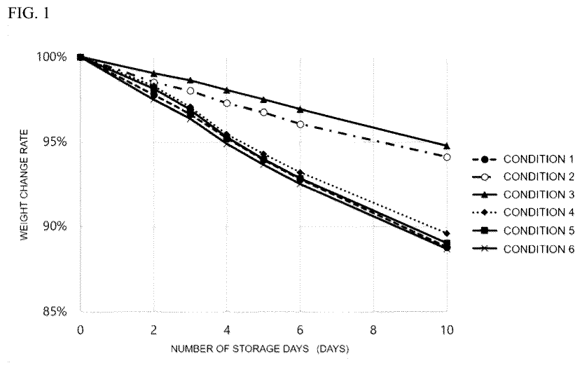

The result is shown in FIG. 1. In Condition 2 and Condition 3, it was possible to significantly reduce the weight loss with respect to Condition 1. When the number of days of 95% weight preservation, which is a freshness index, was calculated, while the number of days under Condition 1 was 4 days, the number of days was extended to 8 to 10 days under Condition 2 and Condition 3. That is, the freshness preservation effect under Condition 2 and Condition 3 was from 2 times to 2.5 times the freshness preservation effect under Condition 1. In the appearance observation, under Condition 2 and Condition 3, there was glossiness as compared with Condition 1 even 10 days after storage.

On the other hand, under Conditions 4 to 6, no significant advantage was observed over Condition 1. In the appearance observation, under Condition 6, light-burn of the pericarp was seen after about 1 day. The term “light-burn” mentioned here means a state of having visually changed in color to brown, and when light-burn occurs, the product is brought into an unsuitable state.

The illuminance (mW/cm²) of the present result was measured using a photodiode sensor (model: PD300-UV: Ophir) whose sensitivity was calibrated with the peak wavelength of the used LED. The irradiation amount (mJ/cm²) was calculated as the product of the illuminance (mW/cm²) and the irradiation time (sec). The illuminance and the irradiation amount in the present description can be measured or calculated similarly.

This result indicates that weight loss during storage at 15° C. can be reduced by irradiating both sides of the strawberries after harvest with light having a peak wavelength of 280 nm at an irradiation amount in a range from 18 mJ/cm² to 54 mJ/cm². Such an effect was hardly seen in a range where the irradiation amount was in a range from 180 mJ/cm² to 414 mJ/cm².

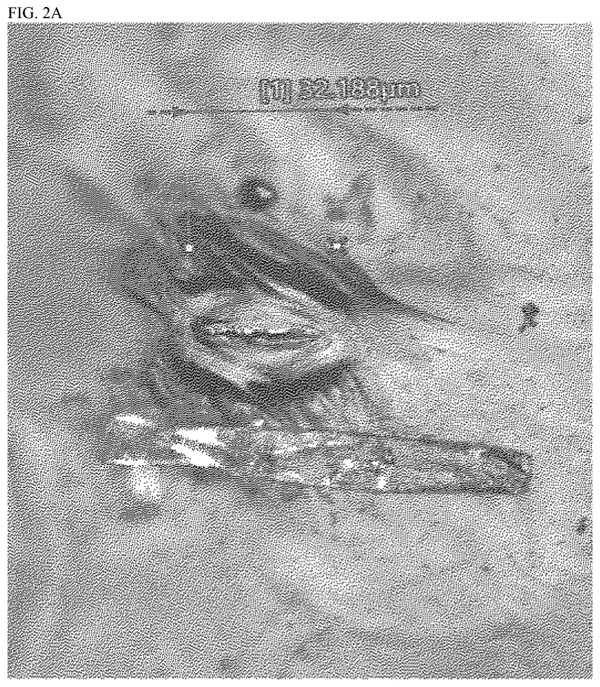

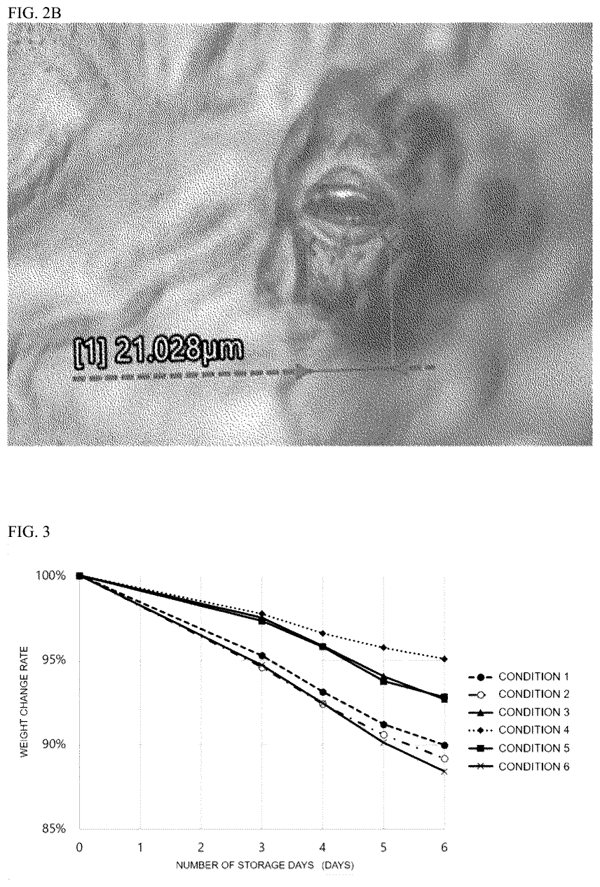

After the storage test ended, the strawberries under Condition 1 and the strawberries under Condition 3 were observed by using an optical microscope, and it was found that the ratio of closed stomata under Condition 3 was higher than the ratio of closed stomata under Condition 1. Specifically, the ratio of closed stomata was 50% in Condition 1, whereas the ratio of closed stomata was 76% in Condition 3. FIGS. 2A and 2B are photographs showing a state of a stoma observed by an optical microscope. FIG. 2A is a photograph in which a state where the stoma is closed is observed, and FIG. 2B is a photograph in which a state where the stoma is opened is observed.

One of the mechanisms for reducing the weight loss is considered to be due to reduction of moisture evaporation by stoma closing. It is considered that by irradiating with light having a peak wavelength of 280 nm, an ultraviolet response by the UVR8 photoreceptor having an absorption peak at 280 nm is involved, and stoma closing is promoted.

### Experiment 2

Next, Experiment 2 in which the irradiation conditions were changed from Experiment 1 was conducted. The change from Experiment 1 is that, in LED irradiation, one side irradiation was performed in which only the upper LED was turned on without turning on the lower LED, and the irradiation amount and illuminance were changed accordingly as shown in Table 2. Other than that, the same device as in Experiment 1 was used, and the freshness preservation effect was checked under the same conditions. The storage method and the weight measurement method were also the same as in Experiment 1.

TABLE 2

| | | IRRADIATION | ILLUMINANCE | IRRADIATION |
|---|---|---|---|---|
| | IRRADIATION METHOD | AMOUNT mJ/cm² | mW/cm² | TIME SECONDS |
| CONDITION 1 | NON-IRRADIATION | 0 | 0.0 | 0 |
| CONDITION 2 | ONE SIDE IRRADIATION | 1 | 0.1 | 18 |
| CONDITION 3 | ONE SIDE IRRADIATION | 5 | 0.3 | 18 |
| CONDITION 4 | ONE SIDE IRRADIATION | 25 | 1.4 | 18 |
| CONDITION 5 | ONE SIDE IRRADIATION | 50 | 2.8 | 18 |
| CONDITION 6 | ONE SIDE IRRADIATION | 100 | 5.6 | 18 |

The result is shown in FIG. 3. In Condition 3 to Condition 5, it was possible to significantly reduce the weight loss with respect to Condition 1. When the number of days of 95% weight preservation, which is a freshness index, was calculated, while the number of days under Condition 1 was 3 days, the number of days was extended to 4.4 to 6 days under Conditions 3 to 5. That is, the freshness preservation effect under Condition 3 to Condition 5 was from about 1.5 times to 2 times the freshness preservation effect under Condition 1. On the other hand, under Condition 2 and Condition 6, no significant advantage was observed over Condition 1.

This result indicates that weight loss during storage at 15° C. can be reduced by irradiating one side of the strawberries after harvest with light having a peak wavelength of 280 nm at an irradiation amount in a range from 5 mJ/cm² to 50 mJ/cm². Such an effect was not seen when the irradiation amount was 1 mJ/cm² and when the irradiation amount was 100 mJ/cm².

The results of Experiment 1 and Experiment 2 indicate that the optimum irradiation amount in the case of using light having a peak wavelength of 280 nm is near from 5 mJ/cm² to 54 mJ/cm².

### Experiment 3

Next, in order to find the influence of irradiation time, Experiment 3 was conducted with the irradiation amount being fixed. The change from Experiment 2 is that the irradiation amount and illuminance were changed as shown in Table 3. The number of strawberries put in one food pack was 15. Other than that, the freshness preservation effect was checked under the same conditions as in Experiment 2.

TABLE 3

| | | IRRADIATION | ILLUMINANCE | IRRADIATION |
|---|---|---|---|---|
| | IRRADIATION METHOD | AMOUNT mJ/cm² | mW/cm² | TIME SECONDS |
| CONDITION 1 | NON-IRRADIATION | 0 | 0 | 0 |
| CONDITION 2 | ONE SIDE IRRADIATION | 50 | 25 | 2 |
| CONDITION 3 | ONE SIDE IRRADIATION | 50 | 5 | 10 |
| CONDITION 4 | ONE SIDE IRRADIATION | 50 | 2.78 | 18 |
| CONDITION 5 | ONE SIDE IRRADIATION | 50 | 0.28 | 180 |

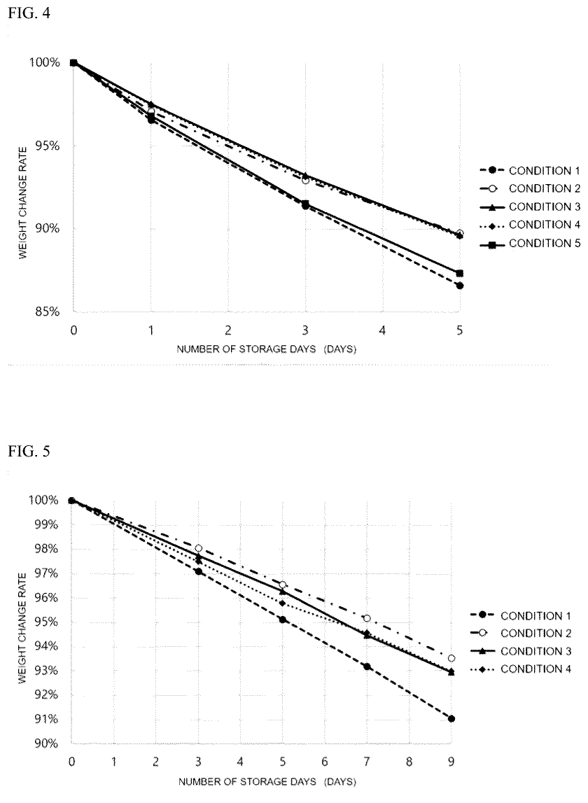

The result is shown in FIG. 4. In Condition 2 to Condition 4, it was possible to significantly reduce the weight loss with respect to Condition 1. When the number of days of 95% weight preservation, which is a freshness index, was calculated, while the number of days under Condition 1 was 1.6 days, the number of days was extended to about 2 days in Conditions 2 to 4. That is, the freshness preservation effect under Condition 2 to Condition 4 was about 1.25 times the freshness preservation effect under Condition 1.

On the other hand, under Condition 5, no significant advantage was observed over Condition 1.

This result indicates that even with the same irradiation amount in the same one side irradiation, the freshness preservation effect was reduced as the irradiation time was lengthened. It was found that weight loss during storage at 15° C. can be reduced by irradiating one side of the strawberries after harvest with light having a peak wavelength of 280 nm for an irradiation time of less than 180 seconds, preferably for an irradiation time of equal to or less than 18 seconds. It is considered that an irradiation time that is too long can damage the pericarp by accumulation of active oxygen species and the like, and impair the moisturizing effect of the pericarp.

The reason why the number of days of 95% weight preservation in Condition 1 was reduced as compared with that in Experiment 1 and Experiment 2 is considered that since Experiment 3 fell into the late stage of harvesting strawberries, the pericarp was softened and moisture evaporation from the pericarp increased.

Experiment 4 In order to check if there is a difference in the freshness preservation effect depending on the variety of strawberries, unlike Experiment 1 to Experiment 3, Kaorino, which is a November-bearing strawberry for winter and spring harvest, was used. Similarly to Experiment 2, the same device as in Experiment 1 was used in LED irradiation, and one side irradiation was performed in which only the upper LED was turned on without turning on the lower LED. The irradiation conditions are as in Table 4.

TABLE 4

| | | IRRADIATION | ILLUMINANCE | IRRADIATION |
|---|---|---|---|---|
| | IRRADIATION METHOD | AMOUNT mJ/cm² | mW/cm² | TIME SECONDS |
| CONDITION 1 | NON-IRRADIATION | 0 | 0 | 0 |
| CONDITION 2 | ONE SIDE IRRADIATION | 10 | 5 | 2 |
| CONDITION 3 | ONE SIDE IRRADIATION | 50 | 25 | 2 |
| CONDITION 4 | ONE SIDE IRRADIATION | 100 | 50 | 2 |

After the light irradiation, 10 strawberries were put in the same food pack as the food pack in Experiment 1 for each of the irradiation conditions and stored in an incubator at 10° C. The relative humidity was about 458. The weight measurement method was the same as in Experiment 1.

The result is shown in FIG. 5. In any of Condition 2 to Condition 4, it was possible to significantly reduce the weight loss with respect to Condition 1. When the number of days of 95% weight preservation, which is a freshness index, was calculated, while the number of days under Condition 1 was 5 days, the number of days was extended to 6.4 to 7 days under Conditions 2 to 4. That is, the freshness preservation effect under Condition 2 to Condition 4 was from about 1.3 times to 1.4 times the freshness preservation effect under Condition 1.

This result indicates that the effect was reproduced with approximately the same irradiation amount even for the different variety, and also indicates that the irradiation amount was slightly different depending on the variety. In Experiment 4 in which Kaorino was used, the freshness preservation effect was obtained even with the irradiation amount of 100 mJ/cm², which did not exhibit an effect in Experiment 2 in which Pechikahonoka was used.

Using the sample of Experiment 4, measurement of the pericarp hardness and component analysis were performed after the end of the storage test.

### (Hardness Measurement)

For the hardness measurement, a digital simple push-pull gauge S9500 series and an electric stand MODEL-2257 manufactured by Aikoh Engineering Co., Ltd. were used. A cylindrical apex tip (diameter @2 mm) was used, and the pressing speed was 60 mm/min.

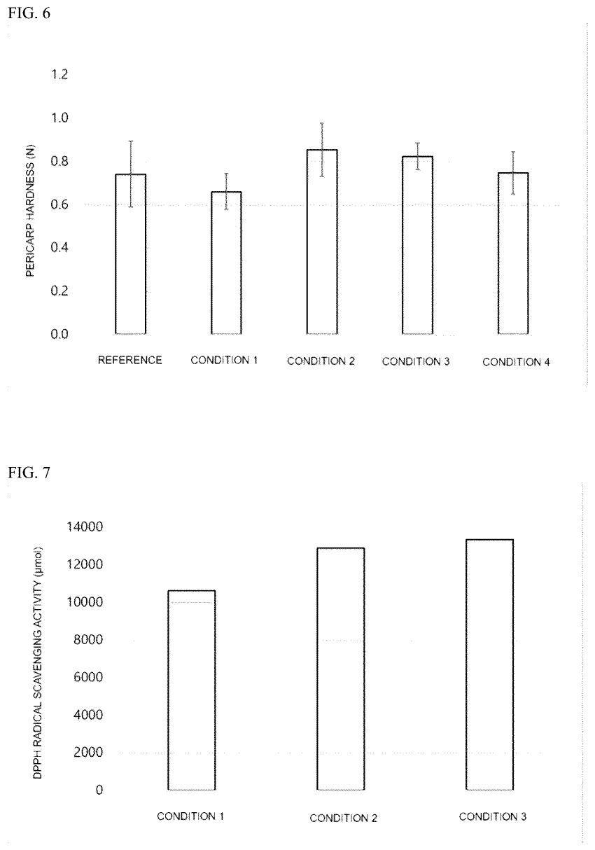

The measurement result of the pericarp hardness is shown in FIG. 6. The graph shows an average value and standard deviation of each 10 pieces. Data of the harvest date is shown as a reference. Condition 1 tended to be lower than the pericarp hardness of the reference, that is, the harvest day, whereas Condition 2 to Condition 4 tended to preserve the pericarp hardness. In particular, a significant difference was seen also in the t-test for Condition 3 (irradiation amount 50 mJ/cm²).

One of the mechanisms for preserving the pericarp hardness is considered to be due to the fact that nitrogen monoxide in cells produced by the ultraviolet response of the UVR8 photoreceptor serves as a signal, and the activity of the pericarp degrading enzyme is suppressed, thereby reducing moisture evaporation.

It is also considered that deactivation of the function of the pericarp degrading enzyme is due to the fact that an amino acid (in particular, tyrosine and tryptophan) that forms a cell wall degrading enzyme or a pectin degrading enzyme that softens the pericarp has an absorption peak at 280 nm. A possibility is considered in which these amino acids were denatured by irradiation with light having a peak wavelength of 280 nm, and the function of the pericarp degrading enzyme was deactivated. It is considered to be not related to UVR8, but it is known that the tissue of fruits and vegetables universally has a cell wall degrading enzyme or a pectin degrading enzyme regardless of plant species, softens the pericarp, the epidermis, and the entire tissue, and is involved in deterioration of freshness due to moisture evaporation. Therefore, it is considered that this effect is also applicable in principle not only to strawberries but also to all postharvest fruits and vegetables.

### Antioxidant Property Measurement

Antioxidant property measurement was performed by a DPPH radical scavenging activity measurement method. The measurement sample was extracted with an ethanol aqueous solution, and the supernatant was used. The result was a DPPH radical scavenging activity value, and was calculated with a Trolox equivalent.

The antioxidant property measurement result is shown in FIG. 7. In both Condition 2 (10 mJ/cm²) and Condition 3 (50 mJ/cm²), it was confirmed that the antioxidant property was increased more than in Condition 1.

### Fisetin Content Measurement

For the fisetin content measurement, liquid chromatography-mass spectrometry (quadrupole type) was used. The measurement sample was extracted with an ethanol aqueous solution, and the supernatant was used. ACQUITY UPLC HSS T3 (2.1 mm×100 mm) was used as a column, a column temperature was 40° C., and a mobile phase had a flow rate of 0.3 mL/min using a 50 mM ammonium formate aqueous solution containing 0.1% formic acid and methanol. The mass spectrometry conditions were ESI Negative mode and SIR (precursor ion m/z 284.9).

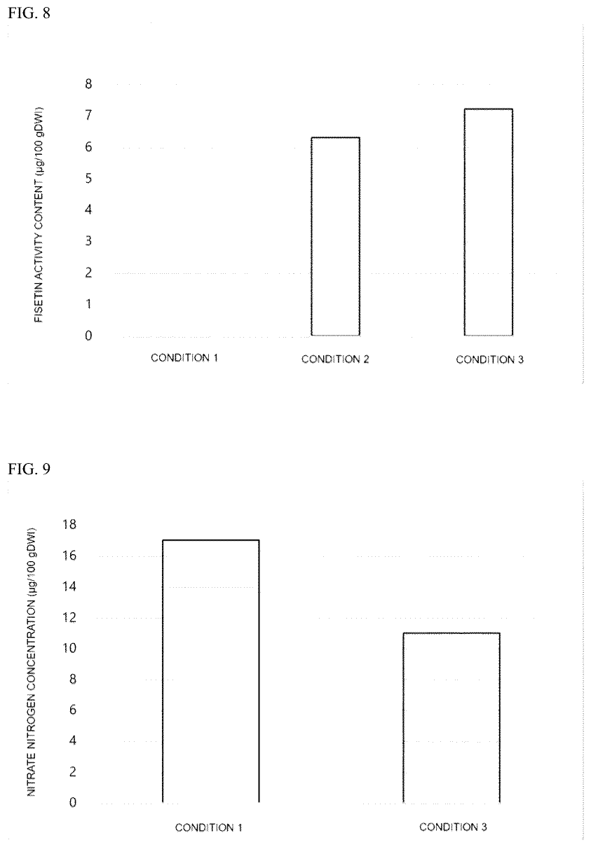

The fisetin content measurement result is shown in FIG. 8. Although the fisetin content in Condition 1 was below the detection limit of the analyzer, the fisetin content in Condition 2 (10 mJ/cm²) and the fisetin content in Condition 3 (50 mJ/cm²) increased significantly.

Nitrate Nitrogen Concentration Measurement The nitrate nitrogen concentration was measured using NO₂/NO₃ Assay Kit-CII (Colorimetric)—Griess Reagent Kit—(manufactured by Dojindo Laboratories). The measurement sample was processed based on the procedure manual of the kit.

The nitrate nitrogen concentration measurement result is shown in FIG. 9. Condition 3 (50 mJ/cm²) was found to be reduced to about 60% as compared to Condition 1.

### Consideration of Measurement Results

The measurement result described above indicates that in Experiment 4, the antioxidant property and fisetin, which are health useful components, increase. Regarding the antioxidant property, intake of fruits and vegetables having a high antioxidant property is recommended in order to remove increased active oxygen in the human body to suppress aging and lifestyle diseases. It is known that fisetin has many physiological active effects such as anti-tumor, anti-oxidation, anti-inflammation, anti-angiogenesis, hyperlipidemia, and neuroprotection.

In Experiment 4, it is found that the nitrate nitrogen concentration decreases. Nitrate nitrogen is not harmful to humans to an extent that it itself is normally ingested. However, it is considered that when nitrate nitrogen is reduced in the body and changed to nitrite ions, it can cause methemoglobinemia, which is one respiration inhibition disease, or change to a nitroso compound, which is a carcinogen.

Therefore, the antioxidant property, an increase in the amount of fisetin, and a decrease in the nitrate nitrogen concentration are preferable in human health.

These mechanisms are considered to be due to the ultraviolet response by the UVR8 photoreceptor having an absorption peak at 280 nm.

### Experiment 5

In order to check if there is a difference in the freshness preservation effect depending on a wavelength other than 280 nm, an experiment in which a wavelength was changed was conducted. For the strawberries, Kaorino, which is a November-bearing strawberry for winter and spring harvest, was used. Similarly to Experiment 2, the same device as in Experiment 1 was used in LED irradiation, and one side irradiation was performed in which only the upper LED was turned on without turning on the lower LED. The irradiation conditions are as in Table 4.

TABLE 5

| | | LIGHT | IRRADIATION | ILLUMINANCE | IRRADIATION |
|---|---|---|---|---|---|
| | IRRADIATION METHOD | SOURCE | AMOUNT mJ/cm² | mW/cm² | TIME SECONDS |
| CONDITION 1 | NON-IRRADIATION | — | 0 | 0 | 0 |
| CONDITION 2 | ONE SIDE IRRADIATION | 254 nm LAMP | 50 | 4 | 12.5 |
| CONDITION 3 | ONE SIDE IRRADIATION | 310 nm LED | 50 | 20 | 2.5 |
| CONDITION 4 | ONE SIDE IRRADIATION | 310 nm LED | 250 | 20 | 12.5 |
| CONDITION 5 | ONE SIDE IRRADIATION | 310 nm LED | 1000 | 20 | 50 |

For the 254 nm lamp, Cosmo Bio Co., Ltd./model number: 3116 0065 1 was used.

After the light irradiation, 10 strawberries were put in the same food pack as the food pack in Experiment 1 for each of the irradiation conditions and stored in an incubator at 10° C. The relative humidity was about 45%. The weight measurement method was the same as in Experiment 1. Wavelength measurement was performed by measuring an emission spectrum using a multichannel detector (model: PMA-11C7473: Hamamatsu Photonics K.K.). The wavelengths in the present description can be measured similarly.

The result is shown in FIG. 11. No effect of reducing weight loss was observed in any of Condition 2 to Condition 5. This result indicates that no freshness preservation effect was observed with the 254 nm lamp and the 310 nm LED.

### Experiment 6

Strawberries with which about 2 hours have elapsed after harvest were irradiated with LED light having a peak wavelength of 270 nm. For the strawberries, Berry Pop Suzu was used. Similarly to Experiment 2, the same device as in Experiment 1 was used in LED irradiation, and one side irradiation was performed in which only the upper LED was turned on without turning on the lower LED. The irradiation conditions are as in Table 6.

TABLE 6

| | | LIGHT | IRRADIATION | ILLUMINANCE | IRRADIATION |
|---|---|---|---|---|---|
| | IRRADIATION METHOD | SOURCE | AMOUNT mJ/cm² | mW/cm² | TIME SECONDS |
| CONDITION 1 | NON-IRRADIATION | — | 0 | 0 | 0 |
| CONDITION 2 | ONE SIDE IRRADIATION | 270 nm LED | 50 | 10 | 5 |

After the light irradiation, 13 strawberries were put in the same food pack as the food pack in Experiment 1 for each of the irradiation conditions and stored in an incubator at 6° C. The relative humidity was about 76%. Weight measurement was performed before storage (i.e., a number of storage days of 0 days) and after 7 days from the start of storage. The weight measurement method was the same as in Experiment 1.

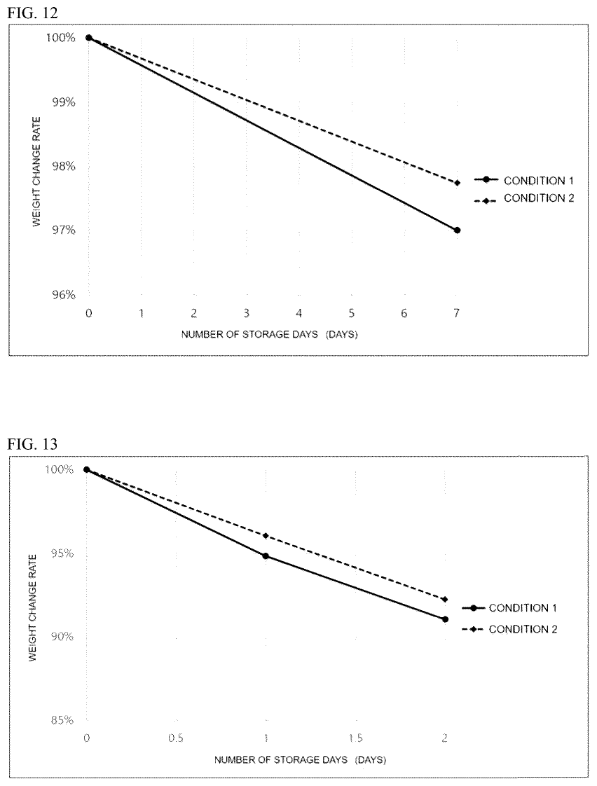

The result is shown in FIG. 12. In Condition 2, it was possible to significantly reduce the weight loss with respect to Condition 1. When the number of weight preservation days in which the weight change rate was 98% was calculated, the number of days was 6.2 days under Condition 2 while the number of days under Condition 1 was 4.7 days. That is, the freshness preservation effect under Condition 2 was about 1.32 times the freshness preservation effect under Condition 1. Therefore, the number of days of 95% weight preservation, which is a freshness index, can be expected to be extended about 1.3 times mathematically.

This result indicates that the experiment examples have revealed that light having a wavelength of 270 nm has the freshness preservation effect similarly to light having a wavelength of 280 nm.

Since the mechanism of freshness preservation is considered to be related to the UVR8 photoreceptor similarly to 280 nm, it is considered that the mechanism is effective in a wavelength region from 256 nm to 400 nm, which is a main wavelength region detected by the UVR8 photoreceptor, and further, it is considered that the mechanism is more effective in a wavelength region from 256 nm to 297 nm, and furthermore, a remarkable effect is exerted in a wavelength region from 265 nm to 297 nm.

Experiment 7 Three cucumbers with which about 6 hours have elapsed after harvest were irradiated with LED light having a peak wavelength of 280 nm. Similarly to Experiment 2, the same device as in Experiment 1 was used in LED irradiation, and one side irradiation was performed in which only the upper LED was turned on without turning on the lower LED. The irradiation conditions are as in Table 7.

TABLE 7

| | | LIGHT | IRRADIATION | ILLUMINANCE | IRRADIATION |
|---|---|---|---|---|---|
| | IRRADIATION METHOD | SOURCE | AMOUNT mJ/cm² | mW/cm² | TIME SECONDS |
| CONDITION 1 | NON-IRRADIATION | — | 0 | 0 | 0 |
| CONDITION 2 | ONE SIDE IRRADIATION | 280 nm LED | 50 | 10 | 5 |

After the light irradiation, the three cucumbers were put in a storage tray of foamed styrol for each of the irradiation conditions, and stored in an incubator at 23° C. The relative humidity was about 40%. Weight measurement was performed before storage (i.e., a number of storage days of 0 days) and after 1 day and after 2 days from the start of storage. In the weight measurement, three cucumbers taken out from the storage tray were collectively measured.

The result is shown in FIG. 13. In Condition 2, it was possible to significantly reduce the weight loss with respect to Condition 1. When the number of weight preservation days in which the weight change rate was 95% was calculated, the number of days was 1.27 days under Condition 2 while the number of days under Condition 1 was 1 day. That is, the freshness preservation effect under Condition 2 was about 1.27 times the freshness preservation effect under Condition 1.

This result indicates that the experiment examples have revealed that there is a freshness preservation effect by irradiating cucumber with light having a wavelength of 280 nm also on cucumbers similarly to strawberries. It is considered that UVR8 photoreceptors are related to the mechanism of freshness preservation similar to strawberries.

### Experiment 8

One broccoli with which about 6 hours have elapsed after harvest was irradiated with LED light having a peak wavelength of 280 nm. Similarly to Experiment 2, the same device as in Experiment 1 was used in LED irradiation, and one side irradiation was performed in which only the upper LED was turned on without turning on the lower LED. The irradiation conditions are as in Table 8.

TABLE 8

| | | LIGHT | IRRADIATION | ILLUMINANCE | IRRADIATION |
|---|---|---|---|---|---|
| | IRRADIATION METHOD | SOURCE | AMOUNT mJ/cm² | mW/cm² | TIME SECONDS |
| CONDITION 1 | NON-IRRADIATION | — | 0 | 0 | 0 |
| CONDITION 2 | ONE SIDE IRRADIATION | 280 nm LED | 50 | 10 | 5 |

After the light irradiation, the three cucumbers were put in a storage tray of foamed styrol for each of the irradiation conditions, and stored in an incubator at 23° C. The relative humidity was about 40%. Weight measurement was performed before storage (i.e., a number of storage days of 0 days) and after 2 days from the start of storage. In the weight measurement, the weight of one broccoli taken out from the storage tray was measured.

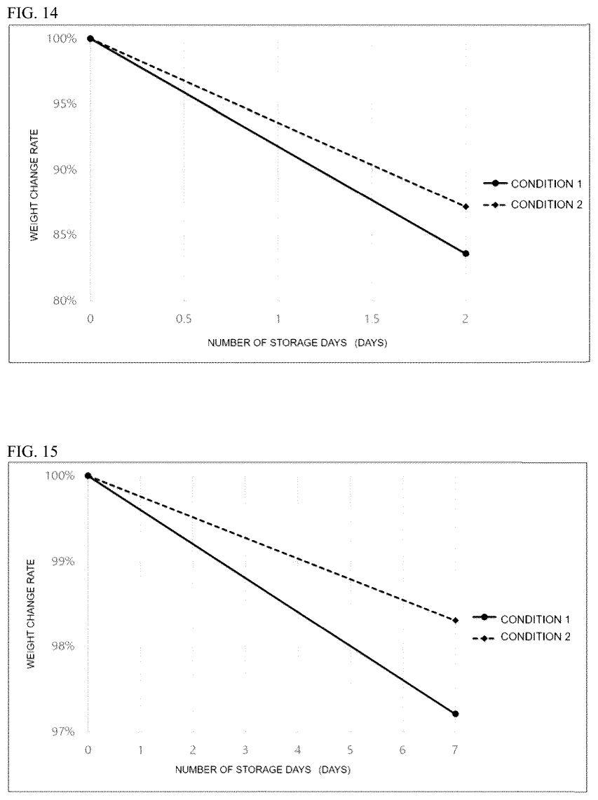

The result is shown in FIG. 14. In Condition 2, it was possible to significantly reduce the weight loss with respect to Condition 1. When the number of weight preservation days in which the weight change rate was 95% was calculated, the number of days was 0.77 days under Condition 2 while the number of days under Condition 1 was 0.61 days. That is, the freshness preservation effect under Condition 2 was about 1.26 times the freshness preservation effect under Condition 1. In the appearance observation, under Condition 2, yellowing of flower buds was reduced for 2 days after storage as compared with Condition 1. This result indicates that the experiment examples have revealed that there is a freshness preservation effect by irradiating cucumber with light having a wavelength of 280 nm also on broccoli similarly to strawberries. It is considered that UVR8 photoreceptors are related to the mechanism of freshness preservation similar to strawberries.

### Experiment 9

An experiment was conducted in which strawberries were irradiated with LED light in a state of being put in a translucent case, and put in a modified atmosphere packaging (MA packaging) material and stored. For the strawberries, Berry Pop Suzu was used. Strawberries with which about 2 hours have elapsed after harvest were irradiated with LED light having a peak wavelength of 280 nm through a translucent case. Similarly to Experiment 2, the same device as in Experiment 1 was used in LED irradiation, and one side irradiation was performed in which only the upper LED was turned on without turning on the lower LED. The irradiation conditions are as in Table 9.

TABLE 9

| | | LIGHT | IRRADIATION | ILLUMINANCE | IRRADIATION |
|---|---|---|---|---|---|
| | IRRADIATION METHOD | SOURCE | AMOUNT mJ/cm² | mW/cm² | TIME SECONDS |
| CONDITION 1 | NON-IRRADIATION | — | 0 | 0 | 0 |
| CONDITION 2 | ONE SIDE IRRADIATION | 280 nm LED | 50 | 10 | 5 |

The translucent case is a food pack, and the irradiation amount and the illuminance are values of the light that was actually applied to the strawberries. Fifteen strawberries were put into the food pack 5 by 5 for each of the irradiation conditions. The material of the food pack was a styrene resin, the lid of the food pack was closed but not sealed, and air flowed in and out.

After the light irradiation, the strawberries were put into a P-Plus (registered trademark. Sumitomo Bakelite Co., Ltd.), which is an MA packaging material, together with the food pack, and stored in an incubator at 23° C. Weight measurement was performed before storage (i.e., a number of storage days of 0 days) and after 7 days from the start of storage. For weight measurement, the food packs were taken out from P-Plus (registered trademark), collectively measured for each of the food packs, and summed up, and the weight of the food pack measured in advance was subtracted from the measured value to calculate the weight of the 15 strawberries.

The result is shown in FIG. 15. In Condition 2, it was possible to significantly reduce the weight loss with respect to Condition 1. When the number of weight preservation days in which the weight change rate was 99% was calculated, the number of days was 4.1 days under Condition 2 while the number of days under Condition 1 was 2.5 days. That is, the freshness preservation effect under Condition 2 was about 1.64 times the freshness preservation effect under Condition 1. Therefore, the number of days of 95% weight preservation, which is a freshness index, can be expected to be extended about 1.6 times mathematically. In the appearance observation, under Condition 2, generation of mold was reduced for 7 days after storage as compared with Condition 1. The mold generation rate was 87% in Condition 1, but decreased to 40% under Condition 2.

This result indicates that the experiment examples have revealed that by emitting light of 280 nm and putting strawberries in the MA packaging material, there is the freshness preservation effect, and in particular, generation of mold can be reduced.

It is considered that sterilization of mold and plant immunity improvement contribute to mold generation reduction. The sterilization effect of mold is mainly caused by generation of cyclobutane-type pyrimidine dimer (CPD) indicating DNA damage of mold and 6-4 type photoproduct (6-4PP). The wavelength range absorbed by DNA indicates that a remarkable effect is exerted particularly in from 256 nm to 297 nm.

The plant immunity improvement effect is considered to be a systemic acquired anti-mold effect by the UVR8 photoreceptor receiving LED light and secreting salicylic acid and the like into the whole body. This is supported by the fact that the mold generation reduction effect was also seen on the back surface of the strawberries, that is, the surface not irradiated with LED light. Therefore, it is considered that the mechanism is effective in a wavelength region from 256 nm to 400 nm, which is a main wavelength region detected by the UVR8 photoreceptor, and further, it is considered that the mechanism is more effective in a wavelength region from 256 nm to 297 nm, and furthermore, a remarkable effect is exerted in a wavelength region from 265 nm to 297 nm. It is suggested to be more effective to irradiate a damaged part with LED light because fruits and vegetables such as strawberries often grow mold from the damaged part.

It is preferable that fruits and vegetables are irradiated with light together with the light translucent case and put in the MA packaging material because workability is improved. By putting fruits and vegetables in a translucent case and then emitting light, it is possible to make it difficult to cause damage at the time of handling the fruits and vegetables.

### Experiment 10

In order to find the influence of light after light irradiation, an experiment was conducted to check if there is a difference in the freshness preservation effect by irradiating strawberries with LED light of 280 nm and then storing the strawberries for a certain period of time under indoor illumination. For the strawberries, Berry Pop Suzu was used. Strawberries with which about 2 hours have elapsed after harvest were irradiated with LED light having a peak wavelength of 280 nm. Similarly to Experiment 2, the same device as in Experiment 1 was used in LED irradiation, and one side irradiation was performed in which only the upper LED was turned on without turning on the lower LED. The irradiation conditions are as in Table 10.

TABLE 10

| | | IRRADIATION | ILLUMINANCE | IRRADIATION | INDOOR |
|---|---|---|---|---|---|
| | IRRADIATION METHOD | AMOUNT mJ/cm² | mW/cm² | TIME SECONDS | ILLUMINATION |
| CONDITION 1 | NON-IRRADIATION | 0 | 0 | 0 | INCLUDED |
| CONDITION 2 | ONE SIDE IRRADIATION | 50 | 10 | 5 | INCLUDED |
| CONDITION 3 | ONE SIDE IRRADIATION | 50 | 10 | 5 | NONE |

After the light irradiation, 8 strawberries were put in the same food pack as the food pack in Experiment 1 for each of the irradiation conditions and stored in a laboratory at a room temperature of 23° C. for 1 hour under indoor illumination of about 20 μmol/m²/s and in a cardboard box so as not to be illuminated with indoor illumination, and then stored in an incubator at 6° C. The relative humidity was about 768. Weight measurement was performed before storage (i.e., a number of storage days of 0 days) and after 5 days and after 10 days from the start of storage. The weight measurement method was the same as in Experiment 1.

The result is shown in FIG. 16. In Condition 2 and Condition 3, it was possible to significantly reduce the weight loss with respect to Condition 1. When the number of days of 95% weight preservation, which is a freshness index, was calculated, while the number of days under Condition 1 was 4 days, the number of days under Condition 2 was 5 days and the number of days under Condition 3 was 6.4 days. That is, the freshness preservation effect under Condition 2 was about 1.25 times the freshness preservation effect under Condition 1, and the freshness preservation effect under Condition 3 was about 1.6 times the freshness preservation effect under Condition 1.

This result indicates that the experiment examples have revealed that the weight loss during storage at 6° C. can be further reduced by irradiating the strawberries with light of 280 nm and preventing indoor illumination from being applied after light irradiation. This is considered to be because blue light contained in the indoor illumination acts on the stoma opening, thereby suppressing the effect of reducing moisture evaporation.

### REFERENCE SIGNS LIST

100 Light irradiation device; 10 LED module; 12 LED; 14 LED mounting board; 16 Heat sink; 20 Fruits and vegetables; 30 LED power supply; 40 Sequencer; 50 Fan; 60 Measure; 70 Tray; 72 Placement surface; 80 Jack; and 90 Stage.

What is claimed is:

1. A freshness preservation method for fruits and vegetables, the method comprising:
irradiating fruits or vegetables within 24 hours after harvest with light having a peak wavelength in a range from 256 nm to 297 nm, thereby extending, by equal to or greater than 25% compared to when the fruits or the vegetables are not irradiated by the light, time for preserving equal to or greater than 95% of a weight of the fruits or the vegetables before light irradiation.

2. The freshness preservation method for fruits and vegetables according to claim 1, wherein
the irradiating with the light includes irradiating the light with an integrated light amount of the light being in a range from 5 mJ/cm² to 100 mJ/cm².

3. The freshness preservation method for fruits and vegetables according to claim 1, wherein
the irradiating with the light includes irradiating the light with an integrated light amount of the light being in a range from 5 mJ/cm² to 60 mJ/cm².

4. The freshness preservation method for fruits and vegetables according to claim 1, wherein
the irradiating with the light includes emitting the light in a state where the fruits or the vegetables are placed on a placement member having a placement surface with an average reflectance of the light of equal to or greater than 20%.

5. The freshness preservation method for fruits and vegetables according to claim 1, wherein
the irradiating with the light includes emitting the light to the fruits or the vegetables in a state where the fruits or the vegetables are put in a translucent case.

6. The freshness preservation method for fruits and vegetables according to claim 1, wherein
the fruits or the vegetables are strawberries.

7. The freshness preservation method for fruits and vegetables according to claim 6, wherein
the irradiating with the light includes irradiating the strawberries with the light so that fisetin content in the strawberries after the light irradiation is greater than fisetin content in the strawberries before the light irradiation.

8. The freshness preservation method for fruits and vegetables according to claim 6, wherein
the irradiating with the light includes irradiating the strawberries with the light so that a DPPH radical scavenging activity value of the strawberries after the light irradiation is greater than a DPPH radical scavenging activity value of the strawberries before the light irradiation.

9. The freshness preservation method for fruits and vegetables according to claim 6, wherein
the irradiating with the light includes irradiating the strawberries with the light so that nitrate nitrogen concentration in the strawberries after the light irradiation is less than nitrate nitrogen concentration in the strawberries before the light irradiation.

10. A freshness preservation system comprising:
a collection space in which the fruits or the vegetables are collected;
an irradiation space that includes a light irradiation device configured to perform, on the fruits or the vegetables having been collected, the freshness preservation method according to claim 1;
a storage space in which the fruits or the vegetables on which the freshness preservation method has been performed are stored; and
a processed food product manufacture space in which a processed food product is manufactured using the fruits or the vegetables stored in the storage space.

11. A freshness preservation system comprising:
an irradiation space that includes a light irradiation device configured to irradiate fruits or vegetables within 24 hours after harvest with light having a peak wavelength in a range from 256 nm to 297 nm.

12. The freshness preservation system according to claim 11, wherein
the light irradiation device is configured to irradiate the light with an integrated light amount of the light being in a range from 5 mJ/cm² to 100 mJ/cm².

13. The freshness preservation system according to claim 11, wherein
the light irradiation device is configured to irradiate the light with an integrated light amount of the light being in a range from 5 mJ/cm² to 60 mJ/cm².

14. The freshness preservation system according to claim 11, wherein
the irradiation space further includes a placement member having a placement surface on which the fruits or the vegetables are placed while being irradiated by the light, the placement surface having an average reflectance of the light of equal to or greater than 20%.
